(19) United States
(12) Patent Application Publication
(10) Pub. No.: US 2007/0073985 A1
(43) Pub. Date: Mar. 29, 2007

(54) System for and method of retrieval-based data redundancy

(76) Inventor: John Wilkes, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/240,871

(22) Filed: Sep. 29, 2005

(51) Int. Cl. G06F 12/16

(52) U.S. Cl. 711/161

(57) ABSTRACT

The present invention provides a system for and method of retrieval-based data redundancy. In an embodiment, a first write operation is performed on a data object at a first storage subsystem to form a first version of the data object, the data object being included among a plurality of data objects of primary data. An identification of the data object is sent to a second storage subsystem. Using the identification of the data object received by the second storage subsystem the data object is retrieved from the first storage subsystem. The retrieved data object is applied to a secondary data at the secondary storage subsystem, the secondary data being redundant of the primary data.

### FIELD OF THE INVENTION

The present invention relates to the field of data storage and, more particularly, to data redundancy.

### BACKGROUND OF THE INVENTION

Remote mirroring is data redundancy technique for coping with failures. A copy of data, sometimes referred to as a ‘primary’ or ‘local’ copy, is updated, for example, by an application program. A redundant copy of the data, sometimes referred to as a ‘secondary’ or 'slave’ copy, usually at a remote site, is updated as well. When a failure occurs that renders the primary copy unusable or inaccessible, the data can be restored from the secondary copy, or accessed directly from there.

A conventional scheme for remote mirroring is synchronous mirroring. Synchronous mirroring is typically performed under control of the site of the primary copy. In response to a write operation initiated by an application program, the primary site writes the data to the primary copy and forwards the data to the site of the secondary copy. The secondary site stores the data and returns an acknowledgement to the primary site. The primary site awaits the acknowledgement from the secondary site before signaling the application that the write operation is complete and before processing a next write request. In this way, the write-ordering of transactions is preserved at both the primary and secondary sites and both sites have up-to-date copies of the data. A drawback to synchronous mirroring is reduced performance caused by delay in awaiting each acknowledgement from the secondary site.

Another scheme for remote mirroring is asynchronous mirroring. In accordance with asynchronous mirroring, the primary site continues to process a next write request without awaiting an acknowledgement from the secondary site. Asynchronous mirroring schemes typically require that the primary site maintain a record for data updates sent to the secondary site. However, data loss can occur in the event of a failure if write-ordering of transactions is not preserved at the secondary site or if the secondary copy is out-of-date.

### SUMMARY OF THE INVENTION

The present invention provides a system for and method of retrieval-based data redundancy. In an embodiment, a method comprises: performing a first write operation on a data object at a first storage subsystem to form a first version of the data object, the data object being included among a plurality of data objects of primary data; sending an identification of the data object to a second storage subsystem; using the identification of the data object received by the second storage subsystem to retrieve the data object from the first storage subsystem; and applying the retrieved data object to secondary data at the secondary storage subsystem, the secondary data being redundant of the primary data.

In another embodiment, a system comprises: a first storage subsystem for performing a first write operation on a data object to form a first version of the data object, the data object being included among a plurality of data objects of primary data; and a second storage subsystem for initiating retrieval of the data object from the first storage subsystem using an identification of the data object received from the first storage system and for applying the retrieved data object to secondary data at the secondary storage subsystem, the secondary data being redundant of the primary data.

These and other embodiments are described in more detail herein.

### BRIEF DESCRIPTION OF THE DRAWINGS

FIG. 1 illustrates a storage system including a first storage subsystem and a second storage subsystem in which the present invention may be implemented;

FIG. 2 illustrates exemplary sequences of write operations in accordance with an embodiment of the present invention; and

FIG. 3 illustrates an exemplary data object description for a write operation including a data object identifier and version indicator in accordance with an embodiment of the present invention.

### DETAILED DESCRIPTION OF THE INVENTION

The present invention provides a data redundancy technique in which a first data storage subsystem acting as a primary storage facility performs a write operation to update its local copy of a data object. Rather than immediately sending the updated data object to a second storage subsystem acting as a secondary storage facility, the first storage subsystem instead sends a description of the data object to the second storage subsystem. The description of the data object includes an identifier of the data object, such as its address and length, and may also include a version indicator of the data object, such as a hash of its value. The primary storage facility need not thereafter maintain any data regarding the status of the update.

The second storage subsystem retrieves the updated data object at a time that is appropriate for the second storage subsystem by sending a request for the data object to the first storage subsystem. Multiple storage subsystems acting as secondary storage facilities may each retrieve the updated data object at times appropriate for them. Thus, responsibility for maintaining the secondary copy is primarily with the secondary facility (or facilities), which reduces the workload of the primary storage facility. A secondary storage facility retrieves data objects when appropriate for it, which allows the secondary storage facility to better utilize its resources by smoothing its workload over time.

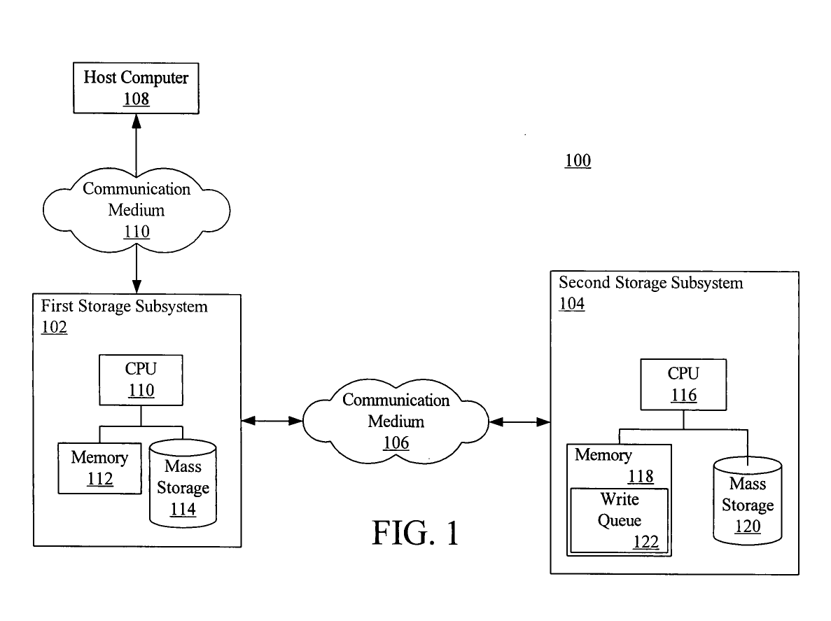

FIG. 1 illustrates a data storage subsystem 100 by which the present invention may be implemented. The system 100 includes a first data storage subsystem 102, a second data storage subsystem 104 and a communication medium 106, such as a network, for interconnecting the first and second storage subsystems 102 and 104.

Additional devices, such as one or more computer(s) 108 (e.g., a host computer, a workstation or a server), may communicate with the first storage subsystem 102 (e.g., via communication medium 110). While FIG. 1 illustrates the communication medium 106 and the communication medium 110 as being separate, they may be combined. For example, communication between the computer 108 and the first storage subsystem facility 102 may be through the same network as is used for the first storage subsystem 102 and the second storage subsystem 104 to communicate.

One or more applications operating at the computer 108 may access the first storage subsystem 102 for performing write or read operations to or from data objects, such as data blocks, files or storage volumes, stored at the subsystem 102. More particularly, the computer 108 may retrieve a copy of a data object by issuing a read request to the facility 102. Also, when a data object at the computer 108 is ready for storage at the facility 102, the computer 108 may issue a write request to the facility 102. For example, the computer 108 may request storage of a file undergoing modification by the computer 108. While a single computer 108 is illustrated in FIG. 1, it will be apparent that multiple computers may access the data storage subsystems 102 and 104. In addition, a storage subsystem may include any number of devices that retrieve, modify and/or generate data and any number of storage subsystems acting as primary or secondary storage facilities. Further, a device, such as a workstation or server, may also function as a storage facility. Still further, a storage subsystem may function as a primary storage facility for some data and as a secondary storage facility for other data, and a storage facility may function as a computer system, such as by generating storage requests (e.g., as part of a backup process). The connections between the various components shown in FIG. 1 are exemplary: any other topology, including direct connections, multiple networks, multiple network fabrics, etcetera, may be used.

For increasing data reliability in the event of a fault at the first storage subsystem 102, data that is redundant of data stored at the first storage subsystem 102 is stored at the second storage subsystem 104. In this case, the first storage subsystem 102 acts as a primary storage facility for the data while the second storage subsystem 104 acts as a secondary storage facility for the data. For example, the second storage subsystem 104 may store a single mirrored copy of data stored by the first storage subsystem 102. Alternatively, the redundant data may be arranged according to another redundancy scheme in which redundant data is distributed among or striped across multiple storage devices or subsystems or in which the redundant data is stored using parity-based error correction coding. For example, the redundant data may be stored at a secondary storage facility (or a plurality of secondary storage facilities) in accordance with Redundant Array of Inexpensive Disks (RAID) techniques, such as RAID levels 0, 1, 2, 3, 4 or 5. Thus, one or more additional storage subsystems acting as secondary storage facilities may be provided, in which each stores only a portion of the data stored at the primary storage facility (thus, proving a distributed redundant copy) or where each stores a complete copy of the data (thus, providing multiple redundant copies). Further, the primary storage facility may itself store data redundantly, such as by employing any RAID technique on data stored at the primary storage facility.

In absence of a fault at the first storage subsystem 102, the computer 108 generally does not direct write and read accesses to the second storage subsystem 104. Rather, for performing write and read operations, the computer 108 accesses the first storage subsystem 102. The first storage subsystem 102 and the second storage subsystem 104 then interact to provide redundant data at the second storage subsystem 104. In the event of a fault at the first storage subsystem 102, lost data may then be reconstructed from the redundant data stored at the second storage subsystem 104 and delivered to the computer 108, or another computer (not shown) may be used to access data at the second storage subsystem facility 104.

For performing its functions, the first storage subsystem 102 may include a CPU or controller 110, a memory 112, such as volatile and/or non-volatile memory, and one or more mass storage devices 114, such as a disk drive (magnetic or optical), disk array or tape subsystem. The mass storage 114 may store a primary copy of data. The second storage subsystem 104 may include a CPU or controller 116, a memory 118, such as volatile and/or non-volatile memory, and one or more mass storage devices 120, such as a disk drive (magnetic or optical), disk array or tape subsystem. The mass storage 120 may store a secondary copy of the data. The primary and secondary copies may include multiple data objects which can be read and written. The memory 118 of the second storage subsystem 104 may include a pending write queue 122 for tracking write operations performed at the first storage subsystem 102, but that have not yet been committed to the secondary copy of the data. The pending write queue 112 is preferably stored in non-volatile memory; it may alternatively be stored on mass storage 120. Computer code for controlling the first and second subsystems 102 to perform functions described herein may be stored on or loaded from computer readable media.

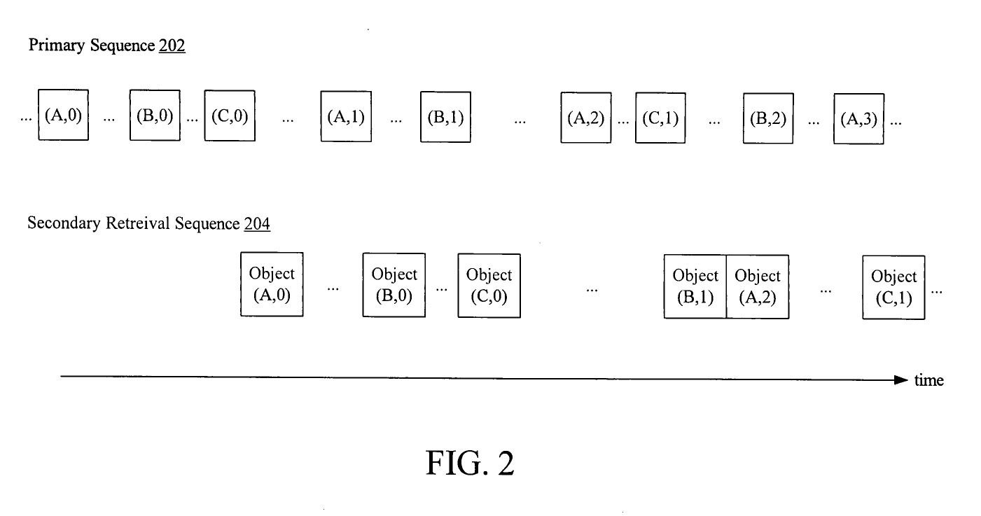

FIG. 2 illustrates exemplary sequences of write operations in accordance with an embodiment of the present invention. An exemplary primary sequence 202 represents an ordering of write operations performed at the first storage subsystem 102 acting as the primary storage facility. Each write operation is represented by a data object identifier and a version indicator. Thus, in FIG. 2, the write operations are for data objects identified by the letters A, B and C, having versions indicated by numerals 0, 1, 2, 3, etcetera. While this example shows three data objects with up to four versions, other examples may have a greater or lesser number of data objects and versions. Time is shown increasing from left to right. The sequence 202 begins at the left-hand side of FIG. 2 with a write operation denoted by (A, 0) to indicate that the version “0” of the data object “A” is written. A next write operation denoted by (B, 0) indicates that the data object “B” is written with version “0,” and so forth, so that the primary sequence 202 shown in FIG. 2 is . . . (A, 0) . . . (B, 0) . . . (C, 0) . . . (A, 1) . . . (B, 1) . . . (A, 2) . . . (C, 1) . . . (B, 2) . . . (A, 3) . . . . The time elapsed between write operations in the primary sequence 202 can vary depending upon the application which generates the operations.

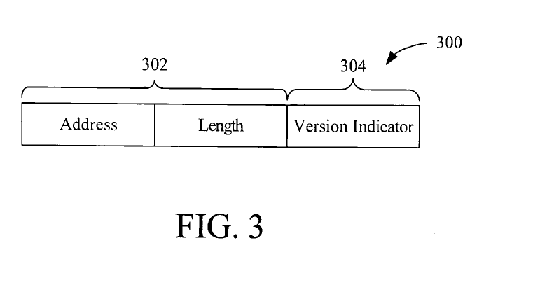

FIG. 3 illustrates an exemplary data object description 300 for a write operation including a data object identifier 302 and version indicator 304 in accordance with an embodiment of the present invention. As shown in FIG. 3, the data object identifier 302 may include the address and length of the data object. The address may identify the location of the data object in the mass storage 114 (FIG. 1) of the first storage subsystem 102 by a logical address or a physical address. The length indicates the size of the stored data object. It will be apparent that some other value or values suitable for identifying the data object, such as a logical volume name or identifier, an object name or a file name, together with an offset within the named entity, may be used for the object identifier 302.

The version indicator 304 for the data object may include a hash value of the data object or some other value suitable for indicating the version of the data object. For example, the version indicator 304 may include a logical timestamp, such as clock value which indicates the time that the object was written at the primary storage facility or a sequence number that is incremented each time the object is overwritten at the primary storage facility or which is incremented each time the primary storage facility generates a new transaction description 300. If the version indicator cannot be derived from the data object itself, then the primary storage facility also stores the version indicator in addition to the data. Otherwise, if the version indicator can be derived from the data object itself, as is the case where the version indicator is a hash value, then the identifier can be derived from the data object when needed and need not be stored at the primary storage facility. Alternatively, the version indicator may be omitted from the description 300 sent to the secondary storage facility, if protection against over-writes and out-of-order updates is not required.

As mentioned, rather than forwarding the data objects themselves, a transaction description (e.g., as shown in FIG. 3) for each data object written at the primary storage facility is first forwarded to the secondary storage facility. The descriptions are forwarded to the secondary storage facility in the order the corresponding operations are performed and generally contemporaneously with the performance of the corresponding operation. Thus, the primary sequence 202 also represents an ordering of the descriptions of the write operations as they are received by the second storage subsystem 104 acting as a secondary storage facility.

The descriptions 300 may be stored in the pending write queue 122 of the second storage subsystem 104 (FIG. 1) acting as the secondary storage facility. Optionally, descriptions of adjacent, consecutive writes may be merged by either the primary or secondary storage facility in order to reduce the size of the description data. For example, a single address and length may identify data written to adjacent locations in two or more consecutive write transactions.

After descriptions of new transactions are received and stored by the secondary storage facility, the secondary storage facility sends requests for the data objects that correspond to the previously received descriptions. Thus, the secondary storage facility first receives the description for a write transaction and then retrieves the corresponding object itself. The primary storage facility initiates the sending of the descriptions to the secondary storage facility, whereas, the secondary storage facility initiates retrieval of the corresponding updated data objects. This retrieval may be concurrent with continuing operations at both the primary and secondary storage facilities.

Once the primary storage facility sends the description of a particular write transaction to the secondary storage facility, the primary storage facility need not thereafter maintain any information as to the status of the transaction at the secondary storage facility. In an embodiment, the secondary storage facility does not generate any indication to the primary that it has received the description. Thus, the primary storage facility may signal to the application that generated the write transaction that the transaction is complete without the need to receive an acknowledgement from the secondary storage facility. To protect against possible communication loss, communication protocols that incorporate reliability measures (such as TCP/IP, or others) can be used to ensure that no descriptions are lost. Alternatively, the description 300 can be augmented with a sequence number generated by the primary facility, and incremented with each new description it generates, so that the secondary facility can detect from the received sequence numbers if it is missing any descriptions. Thus, such sequence numbers can be used as version identifiers and to detect missing descriptions.

In an alternative embodiment, the secondary storage facility returns an acknowledgement to the primary storage facility for each description received by the secondary storage facility. Once the acknowledgement is received, the primary storage facility may signal to the application that generated the write operation that the transaction is complete. If an acknowledgment is not received, the primary storage facility may repeat sending the description until it receives an acknowledgement. If no acknowledgement is received after a predetermined number of tries, the primary storage facility may refuse to accept a next write request from the application that generated the write operation.

FIG. 2 shows a secondary retrieval sequence 204, which represents an ordering of data objects corresponding to the write operations in the primary sequence 202 as they are retrieved by the secondary storage facility. Thus, the sequence 204 begins at the left-hand side of FIG. 2 with a data object denoted by “Object (A, 0)” to indicate retrieval of version 0 of the data object A. A next data object denoted by “Object (B, 0)” indicates retrieval of version 0 of data object B, and so forth.

The secondary sequence 204 generally follows the write-ordering of transactions in the primary sequence 202, but lags behind the primary sequence 202 in time. Thus, FIG. 2 shows a delay between the primary storage facility forwarding the description of the transaction (A, 0) to the secondary storage facility and the secondary storage facility retrieving the corresponding data object, Object (A, 0). Similarly, the FIG. 2 shows a delay between the primary storage facility forwarding the description of the transaction (B, 0) to the secondary storage facility and the secondary storage facility retrieving the corresponding data object, Object (B, 0), and a delay between the primary storage facility forwarding the description of the transaction (C, 0) to the secondary storage facility and the secondary storage facility retrieving the corresponding data object, Object (C, 0). The time elapsed between retrieval of data objects in the secondary sequence 204 can vary depending upon the availability of, and load on, secondary storage facility or communication network 106 or both, and, thus, the time delay between the secondary storage facility receiving a description of the updated data object and the secondary storage facility retrieving the data object itself can vary.

Depending on the circumstances, a data object may have been overwritten with a new version at the primary storage facility before the secondary storage facility attempts to retrieve the object. Referring to the example of FIG. 2, after retrieving the data object Object (C, 0), the secondary storage facility may attempt to retrieve the data object Object (A, 1) since this ordering corresponds to the primary sequence 202. However, by this time, the object Object (A, 1) may have been overwritten at the primary storage facility by a new version of this object Object (A, 2). This is shown in the primary sequence by the transaction (A, 2). Thus, when the secondary storage facility attempts to retrieve a data object using its identifier from a transaction description, it may instead retrieve a different, most-recent version of the object, which in this example is Object (A, 2).

If, in the interim between the updates to a particular data object, any other data object(s) had been updated and the secondary storage facility were to then apply the particular updated data object to its secondary copy of the data without applying the other updated object(s), the secondary copy would not be consistent with the primary copy because the write-ordering would not be preserved. In the example of FIG. 2, the data object, Object (B, 1), is written after Object (A, 1), but before Object (A, 2) in the primary sequence 202. Thus, if the secondary storage facility were to apply Object (A, 2) to its secondary copy without also applying Object (B, 1), the write ordering would not be preserved. In some applications, this is an acceptable tradeoff of storage-system simplicity against application requirements, but in others, this can result in unrecoverable data loss if a failure occurs before the write ordering can be re-established.

The second storage subsystem 104 acting as a secondary storage facility may detect that a data object has been overwritten at the primary storage facility after the object is retrieved by comparing the version of the retrieved data object to the version associated with the operation in the primary sequence 202. To accomplish this, the secondary storage facility may compute the hash of the retrieved data object and compare it to the hash it previously received from the primary storage facility, e.g., the hash 304 (FIG. 3). Alternatively, rather than having the secondary storage facility compute the version, the primary storage facility may respond to a request for a data object from the secondary storage facility by sending the version indicator for a data object along with the data object itself. Thus, the primary storage facility may send the hash for the data object or its logical timestamp to the secondary storage facility, which then compares it to the hash or logical timestamp it previously received in the transaction description. In the example, the secondary storage facility compares the version of the retrieved data object A, which is version 1, to its record of the transaction (A, 0) that is previously received, and discovers that the versions do not match. This indicates that the object has been overwritten.

Alternatively, rather than the secondary storage facility comparing the versions to detect that a data object has been overwritten at the primary storage facility, this could be done elsewhere, such as at the first storage subsystem 102 acting as the primary storage facility. In this case, the secondary storage facility may send the version indicator for the object it is requesting to the primary storage facility along with the identification of the object. Thus, the secondary storage facility may return the complete transaction description (e.g., description 300) to the primary storage facility. The primary storage facility may then compare its most-recent version for the data to the version received from the secondary storage facility. The primary storage facility may then send a notification to the secondary storage facility that indicates whether the data has been overwritten along with the data.

When the secondary storage facility discovers that a data object requested from the primary storage facility has been overwritten, the secondary storage facility may, at this point, stop processing further updates to its secondary copy of the data so as to maintain the write ordering of the updates already processed. In this case, the secondary copy will then become increasingly out-of-date as the primary storage facility continues to process write requests unless further action is taken. Alternatively, the secondary storage facility may simply apply the updated data to its local copy without preserving the write ordering of the transactions. While this will keep the secondary copy more up-to-date, the secondary copy may become inconsistent with the primary copy.

Alternatively, updates that would be inconsistent if they were applied independently can be accumulated until a consistency point where write-ordering equivalence has been achieved, and then applied together, as follows. When a data object requested from the primary storage facility has been overwritten and the secondary storage facility has another update to this same data object in its transaction queue, it may obtain a consistent copy of the data as though the write ordering had been preserved and if it applies all of the operations in the queue up to and including the next update to this data object. Returning to the example of FIG. 2 in which the secondary storage facility receives Object (A, 2) from the primary storage facility when it had been expecting Object (A, 1), because the transaction (A, 2) appears later in its transaction queue, the secondary storage facility may then retrieve all of the data objects which were updated between the transaction (A, 1) and the transaction (A, 2). In the example, this includes the data object, Object (B, 1), since the corresponding transaction (B, 1) appears in the primary sequence 202 between the transactions (A, 1) and (A, 2). Thus, as shown in FIG. 2, data objects, Object (A, 2) and Object (B, 1), may be applied to the secondary copy together, as a whole.

Once the data objects, Object (A, 2) and Object (B, 1), are applied, the secondary copy will be consistent with the primary copy as though the write ordering of the transactions had been preserved. However, if one of the data objects to be applied together as whole has itself been overwritten, then the applying this group will not obtain a consistent copy of the data. Returning to the example, if the object, Object (B, 1), had been overwritten before it was retrieved, then the secondary storage facility would have received the updated object, such as Object (B, 2) in response to its request for the Object(B, 1). In this case, it may be possible for the secondary storage system to maintain consistency between the secondary copy and the primary copy if it then retrieves all of the data objects which were updated between the transaction (B, 1) and the transaction (B, 2) and applies them together along with the data object, Object (B, 2).

In an embodiment, rather than the primary storage facility overwriting a data object in place in response to a write operation to the data, the primary storage facility may write the updated data object to a new location at the primary storage facility thereby maintaining multiple versions of the same data object. In this embodiment, the transaction description sent from the primary storage facility to the secondary storage facility for each write operation (and queued at the secondary facility) includes a version indicator which may be a logical timestamp (e.g., a clock value or a sequence number). Using a logical timestamp allows the relative write ordering of the versions to be determined from the timestamps. A hash value of the data object may optionally be sent as well. When the secondary storage facility then requests the data object corresponding to each transaction in its queue (e.g., queue 122), it also identifies the particular version to the primary storage facility. The primary storage facility then responds by providing the requested version of the data even if the data has since been updated. The secondary storage facility then applies this version to its local copy. In this way, write transactions are retrieved and applied serially, thereby preserving the write ordering of the transactions.

As mentioned, if version indicators other than hash values, such as logical timestamps, are employed the primary storage facility stores the version indicator for a data object in addition to the data object itself. In this case, the logical timestamps may be stored in volatile memory, since a recovery from a loss of the timestamps at the primary storage facility could be performed by the secondary storage facility retrieving the most-recent version of each updated data object identified in its transaction queue and applying them together as a whole. Alternatively, the logical timestamps may be stored in non-volatile memory (e.g., memory 112) separate from the data itself since this would prevent the loss of the logical timestamps in the event of certain failures at the primary storage facility, such a temporary loss of power. As another alternative, the logical timestamps may be stored in mass storage (e.g., massage storage 114 of FIG. 1) either in a data structure dedicated to metadata (e.g., the timestamps) or tightly bound with the corresponding data objects themselves.

A garbage collection technique may be employed to limit the storage of copies of data objects at the primary storage facility that are not expected to be retrieved again by the secondary storage facility. For example, any data object older (an indicated by its logical timestamp), than the oldest data object requested for retrieval by all of the secondary storage facilities could be discarded. Alternatively, the secondary storage facilities could periodically notify the primary storage facility of a cut-off time for which the secondary storage facility no longer needs access to data objects older than the cut-off time. As another alternative, data objects whose logical timestamps are older than a predetermined time period (e.g., a day) could be discarded. These garbage collection techniques or other garbage collection techniques could be used in conjunction with each other.

The foregoing detailed description of the present invention is provided for the purposes of illustration and is not intended to be exhaustive or to limit the invention to the embodiments disclosed. Accordingly, the scope of the present invention is defined by the appended claims.

What is claimed is:

1. A method for managing a storage system having first and second storage subsystems, the method comprising:
performing a first write operation on a data object at the first storage subsystem to form a first version of the data object, the data object being included among a plurality of data objects of primary data;
sending an identification of the data object to the second storage subsystem;
using the identification of the data object received by the second storage subsystem to retrieve the data object from the first storage subsystem; and
applying the retrieved data object to secondary data at the secondary storage subsystem, the secondary data being redundant of the primary data.

2. The method according to claim 1, further comprising sending a version indicator of the first version of the data object from the first storage subsystem to the second storage subsystem.

3. The method according to claim 2, further comprising determining from the version indicator whether a second write operation was performed to overwrite the data object after the first write operation.

4. The method according to claim 3, the version indicator comprising a first hash of the first version of the data object and said determining comprising computing a second hash of the retrieved data object and comparing the first hash to the second hash.

5. The method according to claim 4, wherein the second hash is computed at the first storage subsystem.

6. The method according to claim 4, wherein the second hash is computed at the second storage subsystem.

7. The method according to claim 3, wherein the version indicator comprises a first logical timestamp associated with the first write operation and said determining comprising comparing the first logical timestamp to a second logical timestamp associated with the retrieved data.

8. The method according to claim 1, wherein the secondary data is a mirror copy of the primary data.

9. The method according to claim 1, wherein the secondary data is stored in accordance with parity-based error correction coding.

10. The method according to claim 1, wherein the first storage subsystem continues to perform write operations without waiting for confirmation that the second storage subsystem received the identification of the updated data object.

11. The method according to claim 10, wherein the second storage subsystem determines from sequence numbers whether any identification is missing, the sequence numbers received from the first storage system.

12. The method according to claim 1, wherein the first storage subsystem waits for confirmation that the second storage subsystem received the identification of the updated data object before performing a next write operation.

13. The method according to claim 1, wherein the first storage subsystem performs a second write operation on the data object to form a second version of the data and wherein the second version of the data is written to a different location than that of the first write operation.

14. The method according to claim 13, further comprising sending a first version indicator of the first version of the data object from the first storage subsystem to the second storage subsystem and wherein said using the identification of the data object received by the second storage subsystem to retrieve the data object from the first storage subsystem comprises using the first version indicator to retrieve the first version of the data object.

15. The method according to claim 14, wherein the first version indicator is a logical timestamp.

16. The method according to claim 14, further comprising discarding the first version of the data object at the primary storage facility after the first version of the data object is not expected to be retrieved again.

17. A method for managing a storage system having first and second storage subsystems, the method comprising:
performing a first write operation on a data object at the first storage subsystem to form a first version of the data object;
sending an identification of the data object and a version indicator of the first version of the data object to the second storage subsystem;
using the identification of the data object received by the second storage subsystem to request the data object from the first storage subsystem; and
determining from the version indicator whether a second write operation was performed on the data object after the first write operation.

18. The method according to claim 17, the version indicator comprising a hash of the first version of the data object.

19. The method according to claim 17, the version indicator comprising a first hash of the first version of the data object and said determining comprising computing a second hash of the data object requested from the first storage subsystem and comparing the first hash to the second hash, wherein if there is a match, this indicates that there was not a second write operation performed on the data object, and, if there is not a match, this indicates that a second write operation was performed on the data object.

20. The method according to claim 19, wherein the second hash is computed at the first storage subsystem after the data object is requested by the second storage subsystem.

21. The method according to claim 19, wherein the second hash is computed at the second storage subsystem after the data object is received by the second storage subsystem.

22. The method according to claim 17, wherein the second storage subsystem maintains secondary data that is redundant of primary data stored by the first data storage subsystem and if it is determined that a second write operation was not performed on the data object after the first write operation, then the second storage subsystem writes the data object to its secondary data.

23. The method according to claim 17, wherein the second storage subsystem maintains secondary data that is redundant of primary data stored by the first data storage subsystem and if it is determined that a second write operation was performed on the data object after the first write operation, then the second storage subsystem does not write the data object to its mirror copy.

24. The method according to claim 17, wherein the second storage subsystem maintains secondary data that is redundant of primary data stored by the first data storage subsystem and if it is determined that a second write operation was performed on the data object after the first write operation, then the second storage subsystem retrieves all data objects written to the primary data between the first and second write operations and applies them to the secondary data as a whole with the data object.

25. The method according to claim 17, wherein the version indicator comprises a first logical timestamp associated with the first write operation and said determining comprising comparing the first logical timestamp to a second logical timestamp associated with the requested data.

26. The method according to claim 17, wherein the second storage subsystem maintains a mirror copy of primary data stored by the first data storage subsystem.

27. The method according to claim 17, wherein the first storage subsystem continues to perform write operations without waiting for confirmation that the second storage subsystem received the identification of the updated data object.

28. The method according to claim 17, wherein the first storage subsystem waits for confirmation that the second storage subsystem received the identification of the updated data object before performing a next write operation.

29. A storage system comprising:
a first storage subsystem for performing a first write operation on a data object to form a first version of the data object, the data object being included among a plurality of data objects of primary data; and
a second storage subsystem for initiating retrieval of the data object from the first storage subsystem using an identification of the data object received from the first storage system and for applying the retrieved data object to secondary data at the secondary storage subsystem, the secondary data being redundant of the primary data.

30. The system according to claim 29, wherein a version indicator of the first version of the data object is sent from the first storage subsystem to the second storage subsystem.

31. The system according to claim 30, wherein the second storage subsystem determines from the version indicator whether a second write operation was performed to overwrite the data object after the first write operation.

32. The system according to claim 31, wherein the version indicator comprises a first hash of the first version of the data object and wherein the second storage subsystem determines whether a second write operation was performed by computing a second hash of the retrieved data object and comparing the first hash to the second hash.

33. The system according to claim 31, wherein version indicator comprises a sequence number and wherein the second storage subsystem determines from a plurality of sequence numbers whether an identification of a data object is missing.

34. A storage system comprising:
a first storage subsystem for performing a first write operation on a data object to form a first version of the data object, the data object being included among a plurality of data objects of primary data; and
a second storage subsystem for initiating retrieval of the data object from the first storage subsystem using an identification of the data object received from the first storage system and for determining from a version indicator received from the first storage system whether a second write operation was performed on the data object after the first write operation.

35. The system according to claim 34, wherein the version indicator comprises a hash of the first version of the data object.

36. The system according to claim 34, wherein the version indicator comprises a first hash of the first version of the data object and wherein the second storage subsystem determines whether a second write operation was performed on the data object after the first write operation by computing a second hash of the data object requested from the first storage subsystem and comparing the first hash to the second hash.

37. The system according to claim 36, wherein if there is a match, this indicates that there was not a second write operation performed on the data object, and, if there is not a match, this indicates that a second write operation was performed on the data object.

38. The system according to claim 34, wherein the second storage subsystem maintains secondary data that is redundant of primary data stored by the first data storage subsystem and if it is determined that a second write operation was not performed on the data object after the first write operation, then the second storage subsystem writes the data object to its secondary data.

39. A computer readable media comprising computer code for implementing a method for managing a storage system having first and second storage subsystems, the method comprising:
performing a first write operation on a data object at the first storage subsystem to form a first version of the data object, the data object being included among a plurality of data objects of primary data;
sending an identification of the data object to the second storage subsystem;
using the identification of the data object received by the second storage subsystem to retrieve the data object from the first storage subsystem; and
applying the retrieved data object to secondary data at the secondary storage subsystem, the secondary data being redundant of the primary data.

40. A computer readable media comprising computer code for implementing a method for managing a storage system having first and second storage subsystems, the method comprising:
performing a first write operation on a data object at the first storage subsystem to form a first version of the data object;
sending an identification of the data object and a version indicator of the first version of the data object to the second storage subsystem;
using the identification of the data object received by the second storage subsystem to request the data object from the first storage subsystem; and
determining from the version indicator whether a second write operation was performed on the data object after the first write operation.
